(19) United States
(12) Patent Application Publication
(10) Pub. No.: US 2025/0338868 A1
(43) Pub. Date: Nov. 6, 2025

(54) PROCESSING OF WHOLE OILSEEDS FOR MANUFACTURING PROTEIN CONCENTRATES

(71) Applicant: AARHUS UNIVERSITET, Aarhus C (DK)

(72) Inventors: Milena CORREDIG, Aarhus C (DK); Simone Bleibach ALPIGER, Aarhus C (DK)

(21) Appl. No.: 18/864,191

(22) PCT Filed: May 10, 2023
(86) PCT No.: PCT/EP2023/062410

§ 371 Date: Nov. 8, 2024

(30) Foreign Application Priority Data
May 11, 2022 (CA) 3158643
May 11, 2022 (EP) 22172804.1

(51) Int. Cl. A23J 1/14; A23J 3/14; B01D 21/26; C11B 1/06

(52) U.S. Cl. CPC A23J 1/148; A23J 3/14; B01D 21/262; C11B 1/06

(57) ABSTRACT

The present invention relates to a process for processing whole oilseed. In particular, the present invention relates to a process for isolating a protein rich fraction from whole oilseed using acidic pH. The present invention also relates to uses of such protein rich fractions.

### TECHNICAL FIELD OF THE INVENTION

The present invention relates to a process for manufacturing ingredients from whole oilseeds. In particular, the present invention relates to a process for isolating a defatted protein concentrate from whole oilseed using controlled pH conditions. The present invention also relates to uses of such protein concentrates.

### BACKGROUND OF THE INVENTION

In the preparation of ingredients from oil containing crops, high yields of oil are usually the priority. To improve circularity of the value chain, often the by-products of production, still containing valuable macronutrients (i.e. protein, fiber) are also treated and used for animal feed. More recently, these byproducts/side streams have also found uses in extraction processes leading to ingredients with high protein purities. For example, one can find the recent work on oilseed press cake extraction to obtain protein isolates (EP3229603A2; WO 2009/152620 A1; EP2938204B1; EP2400859B2). The further fractionation of proteins from press cakes comes at a cost to the environment, not only because of additional resources used, but also the upstream creation of other by-products. Recent years have seen a growth of focus for the reduction of the environmental footprint by increasing efforts in reducing the level of purity of the ingredients to be used in food formulations (van der Goot et al 2015). It is becoming clear that more sustainable processes can be created if the industry shifts to the simultaneous manufacture of ingredients where purity may be less of a priority, to be able to upgrade what they used to be by-products to co-products.

Oilseeds (e.g. rapeseed, sunflower, hemp, almonds and peanuts) have traditionally been used first and foremost for their high oil content and press cakes or meals rich in proteins and fibers are then produced as by-products. Oilseed proteins can have high nutritional value; however, harsh conditions (i.e. solvent extractions and high temperatures) during high yielding defatting processes lead to high level of protein denaturation, oxidative reactions and the press cakes are therefore no longer suitable for human consumption. Indeed to ensure economic viability of the ingredients obtained great care is needed to ensure a good quality of the high value oil fraction. More gentle defatting processes lead to protein concentrates with high concentration of residual oil (>10%).

Oilseeds are rich in proteins, lipids and fiber, which make them a nutritious food source. The major protein fractions are the storage proteins, which are assembled in protein bodies. They are known to differ in composition, size, supramolecular structure, isoelectric point and solubility. The lipids are also located in membrane bound bodies, so-called oleosomes. The olesomes are surrounded by a membrane composed of phospholipids and stabilizing proteins, oleosines, caleosines and steroleosines. Plant-derived oleosomes have shown unique processing functionalities, which have been suggested to be suitable as texture enhancing, and stabilizing agents and ingredients, for example, to be used to imitate dairy products. Much research is currently being conducted to better utilize intact oleosomes, and to exploit their unique properties.

Recent published literature has demonstrated that proteins and oleosomes can be extracted simultaneously by wet extraction resulting in extracts rich in both protein and oil. Wet extractions are currently performed at alkaline pH conditions as this is reported to optimize extraction yields. For example simultaneous extraction of protein and oleosomes from whole rapeseeds was recently conducted at pH 9.0, resulting in an ingredient containing 40% protein and at least 12% oil, based on dry matter (Ntone et al 2019). However, performing extractions at alkaline pH, in the range between 8 and 10, leads to certain challenges in relation to protein quality, as for example, increased oxidative reactions between proteins and polyphenols, present in large concentration in these extracts.

Oleosome stabilizing proteins are known to have a pI at pH 4-5 leading to increased oleosome stability at alkaline pH. Therefore, literature reports that high centrifugation speeds (i.e. 10,000 g) have been applied to separate protein and oil into two functional fractions: a protein enriched fraction and an oleosome-rich cream fraction (Ntone et al 2019; Romero et al 2020). These simultaneous extractions of the oil enriched and protein enriched fraction ultimately result in lower yields of oil from the seeds, as the protein fraction still contains substantial amount of lipids, and this also creates a high potential to develop off taste due to oxidative reactions.

EP 2 704 587 B1 D1 discloses a process of wet milling of rapeseed (Brassica napus) seeds, allowing for extraction of enzymes such as myrosinase.

US 2017/318834 A1 discloses a process for non-denaturing extraction and isolation of protein from meal or oil cake of oil seeds.

U.S. Pat. No. 5,844,086 A discloses the extraction of an oil seed meal (necessarily milled/comminuted) with a salt solution in water at a pH of about 5-6.8, preferably about 5.3-6.2 to solubilise fat and protein.

Hence, an improved process for isolating oilseed proteins would be advantageous, and in particular, a more efficient process for separating protein and oil fractions, so to obtain a nearly defatted protein concentrate would be advantageous.

### SUMMARY OF THE INVENTION

The extraction methods so far described in the literature, which utilize alkaline pH result in inefficient oil separations, with protein concentrates still containing substantial amounts of oil (for example, a protein:oil ratio of 3.3), with obvious consequences on oxidation and off flavour reactions.

Alkaline extraction conditions (pH 8-10), while resulting in high extraction yields from the seed, also promote polyphenol-protein interactions, known to decrease protein solubility and protein nutritional quality. For example, co-extraction of sinapic acid during rapeseed protein extractions at pH 9.0 or above reduces the techno-functional properties (i.e. solubility and gelling properties) of the protein concentrate (Ntone et al 2019; Ntone et al 2022). A recent publication highlights the importance of using other processing strategies, as for example, extrusion, to remove anti nutritional polyphenols from protein containing raw materials (such as press cakes) from soybean, rapeseed, sunflower, to name a few (Vidal et al 2022). However, these processes also affect the nutritional and technological functionality of the protein.

The process described in this invention addresses the need to create simultaneous extraction of high quality ingredients, while improving simplicity of the processes and economies of scale. The invention suggests processing conditions leading to the creation of a novel oilseed protein concentrate with high protein:oil ratio and oil concentrations<3% (dry basis). Using this process, based on wet milling, two fractions are obtained, with a high efficiency of separation of the oil, using common separation technologies, as those known to the skilled in the art, such as low speed centrifugation or decanters. The cream phase is separated from a skimmed phase, and a defatted protein concentrate slurry is obtained. This leads to an oilseed derived protein concentrate with novel properties (such as high solubility at pH 5) and improved technological functionality and sensory characteristics (i.e. solubility, color) compared to current press cake extracts.

Furthermore, improved separation of oil makes this novel process more economically viable since the oil can be immediately and further processed from the separated cream, either to prepare oleosome extracts, or by further refining of the oil. During this process, high protein yields and modified functionalities can be obtained by combining the extraction with enzymatic treatments. In particular, addition of cell wall-degrading enzymes or controlled proteolysis can improve protein yields and modulate functional and nutritional properties.

It is important to note that these processes have the potential to be fully solvent free, which makes the environmental footprint lower than for the processes currently known.

Example 1 provides an overview of the process according to the invention.

Example 2 shows that the provided protein concentrate can be dried using conventional spraydrying.

Example 3 shows that the protein concentrate extracted at low pH has a high protein concentration and a high protein:oil ratio.

Example 4 shows that a simultaneous treatment with pectinase can increase protein yields.

Example 5 shows that protein concentrations can be further increased by combining extraction with membrane filtration such as ultrafiltration.

Additionally, ultrafiltration can be used to remove non-protein nitrogen, such as glucosinolates, and pigments, such as polyphenols, leading to changes in the composition and the properties of the concentrates.

Example 6 demonstrates that the properties, i.e. dispersibility, of the extracts are different than those of a conventional alkaline extract.

Example 7 demonstrates how protein hydrolysis using commercial endo-proteases can be used to modify the protein solubility of the protein concentrate created in example 1.

Example 8 compares the foaming properties of rapeseed protein concentrates extracted at acidic (5.7) and alkaline (8.5) conditions as described in example 3.

Thus, an object of the present invention relates to a process for processing oilseed. In particular, it is an object of the present invention to provide an oilseed protein concentrate with a high protein:fat ratio and/or low fat content.

Thus, one aspect of the invention relates to a process for manufacturing protein concentrates from oilseeds, such as rapeseed, the process comprising
a) providing oilseeds, preferably completely or partially dehulled;
b) wet-milling the oilseeds from step a) at a pH below 6.5, such as in the range 5-6;
c) optionally, diluting/solubilising the wet-milled oilseed from step b) such as in water such as to a water:seed ratio of at least 5:1 (by weight), thereby providing an oilseed slurry;
d) optionally, enzyme treating the mixture of step b) and/or step c), such as pectinase enzyme treatment;
e) mixing the wet-milled oilseed from step b) or oilseed slurry from step c), preferably at room temp.;
f) separating insoluble fragments, by separating the oilseed slurry from step e) preferably using a twin-screw press, thereby providing an oilseed slurry filtrate;
g) separating the fat from the aqueous slurry, by centrifuging or decanting the oilseed slurry filtrate, preferably at g values in the range 1500-5000 g, to provide an oilseed slurry filtrate comprising at least three fractions:
   I. a lipid fraction;
   II. a soluble protein concentrate fraction; and
   III. a precipitate fraction, comprising fibers;
h) providing the soluble (low fat) protein concentrate fraction (II.).

An aspect also relates to a process for manufacturing protein concentrates from whole or (whole) dehulled oilseed, such as whole rapeseed, the process comprising
a) providing whole oilseeds, preferably completely or partially dehulled whole rapeseed;
b) wet-milling the whole oilseeds from step a) at a pH in the range 5-6;
c) optionally, diluting/solubilising the wet-milled oilseed from step b);
thereby providing an oilseed slurry;
d) optionally, enzyme treating the mixture of step b) and/or step c), such as pectinase enzyme treatment;
e) mixing the wet-milled oilseed from step b) or oilseed slurry from step c);
f) separating insoluble fragments, by separating the oilseed slurry from step e) by screw-pressing, preferably using a twin-screw press, thereby providing an oilseed slurry extract;
g) centrifuging the oilseed slurry extract from step f), preferably at g values in the range 1500-5000 g, to provide at least three fractions:
   I. a lipid fraction;
   II. a soluble protein concentrate fraction; and
   III. a precipitate fraction, comprising fibers;
h) isolating the soluble protein concentrate fraction (II.).

Another aspect of the present invention relates to protein containing oilseed extract obtained/obtainable by a process according to the invention.

Yet another aspect of the present invention is to provide an oilseed extract composition having
a protein content in the range 25-50 wt %; and/or
an oil content below 5 wt %; and/or
a pH in the range 5-6.5; and/or
a protein to fat ratio, by wt % dry matter, in the range 10:1 to 40:1
having a protein solubility above 30, such as above 40, such as in the range 30-65, such as in the range 40-60 in the pH range 5-7, preferably in the pH range 5.5-6.5.

In a preferred embodiment the oilseed extract composition has
a protein content in the range 25-50 wt %; and
an oil content below 5 wt %; and
a protein:fat ratio, by wt % dry matter, in the range 10:1 to 40:1.

A further aspect of the invention relates the use of a protein containing oilseed extract obtained/obtainable by a process according to the invention and/or the oilseed extract according to the invention, in the production of food/feed.

Yet an aspect relates to a food/feed ingredient comprising the protein containing oilseed extract obtained/obtainable by a process according to the invention and/or the oilseed extract according to the invention.

Yet a further aspect of the invention relates to a food/feed product comprising the food ingredient according to the invention.

An additional aspect of the invention relates to the use of the protein containing oilseed extract obtained/obtainable by a process according to the invention and/or the oilseed extract according to the invention or the food ingredient according to the invention as a gelling agent, a foaming agent and/or as an emulsifier.

### BRIEF DESCRIPTION OF THE FIGURES

FIG. 1 shows a schematic representation of the process steps leading to the preparation of the novel rapeseed protein concentrate as described in example 1. (a) indicates extract fraction before centrifugation or decanting, (b) indicates protein concentrate fraction without pectinase treatment, (c) indicates spray dried protein powder fraction (b), (d) indicates protein concentrate fraction with pectinase treatment.

FIG. 2 shows the spray dried powder (c) achieved in example 1.

FIG. 3 shows the protein recovery as percentage of initial protein available in the whole seeds in relation to amount of protein present in the various concentrates achieved at the various extraction conditions.

FIG. 4 shows the protein recovery as percentage of initial protein available in the whole seeds in relation to protein concentration of the protein concentrates achieved at the various extraction conditions compared to pectinase assisted extractions.

FIG. 5 shows (A) visual appearance of permeate fractions transmitted through a ultrafiltration membrane (10 kDa) of the protein concentrate (d). From left to right: permeate collected at various times 10, 20, 30, 50, 70, 90 and 120 min. (B) Nitrogen concentration (% w/w) measured in the permeates obtained from ultrafiltrating (10 kDa) the protein concentrate (d). Nitrogen measured by combustion method.

FIG. 6 shows an electrophoretic pattern measured by SDS-PAGE of (A) the protein concentrate obtained by enzyme assisted extraction (d) measured under non-reducing conditions and (B) the permeate fractions achieved from ultrafiltrating (10 kDa) the protein concentrate (d) for various times up to 2 h (1-7), also measured under non-reducing conditions. M: molecular weight marker.

FIG. 7 shows values of turbidity as a function of pH (in the interval from 3.0 to 10.0) for protein concentrates (A) extracted at pH 5.7 and 9.0 and (B) extracted at pH 5.7 before, as a liquid concentrate (b) and after reconstitution from a spray dried powder (c).

FIG. 8 shows the polyphenol concentration in the permeate at different timepoints during ultrafiltration (10 kDa) of the protein concentrate (b).

The present invention will now be described in more detail in the following.

### DETAILED DESCRIPTION OF THE INVENTION

### Definitions

Prior to discussing the present invention in further details, the following terms and conventions will first be defined:

### Oleosome

In the present context, the term “oleosome” or “oil body” refers to natural oil droplets, abundant in plants and more specifically in seeds, composing 20-50 wt % of their mass. The “oleosomes” are stabilized by unique proteins called “oleosins”, to safely store energy in the form of lipids.

### Protein Concentration

In the present context, protein is measured using the total nitrogen method using a combustion method, and then corrected for a factor of 5.7.

Process for Manufacturing Protein Concentrates from Oilseed

As outlined above and in the example section, the present invention relates to a process for manufacturing protein concentrates from oilseeds, using native pH. Thus, an aspect of the invention relates to a process for manufacturing protein concentrates from oilseed, such as rapeseed, the process comprising
a) providing oilseeds, preferably completely or partially dehulled;
b) wet-milling the oilseeds from step a) at a pH, below 6.5, such as in the range 5-6;
c) optionally, diluting/solubilising the wet-milled oilseed from step b), e.g. in water such as to a water:seed ratio of at least 5:1 (by weight), thereby providing an oilseed slurry;
d) optionally, enzyme treating the mixture of step b) and/or step c), such as pectinase enzyme treatment;
e) mixing the wet-milled oilseed from step b) or oilseed slurry from step c), preferably at room temp. for e.g. 4 hours;
f) separating insoluble fragments, by filtering the oilseed slurry from step e) preferably using a twin-screw press, thereby providing an oilseed slurry filtrate;
g) separating the fat from the aqueous slurry, by centrifuging or decanting the oilseed slurry filtrate, preferably at g values in the range 1500-5000 g, and at a temperature below 10° C., to provide an oilseed slurry filtrate comprising at least three fractions:
   I. a lipid fraction;
   II. a soluble protein concentrate fraction; and
   III. a precipitate fraction, comprising fibers;
h) providing the soluble protein concentrate fraction (II.).

As shown e.g. in example 3 this lower pH (in step b)) provides a protein concentrate fraction having e.g. a high protein concentration and a high protein:oil ratio as compared to processes using higher pH.

The lipid fraction I. (oil fraction) may also be isolated. Thus, in an embodiment, the process further comprises providing the lipid fraction (I.), such as an oil fraction.

The fiber fraction (III.) may also be isolated. Thus, in an embodiment, the process comprises providing the isolated fiber fraction (III).

### Step a)

Different oilseeds may be used in the process according to the invention. Thus, in an embodiment, the oilseed is selected from the group consisting of rapeseed, sunflower, hemp, almonds and peanuts, preferably rapeseed. In a preferred embodiment, the oilseed is rapeseed. The oilseed may be processed before use. Thus, in an embodiment, the oilseed is completely or partially dehulled. In examples 1-6 rapeseed has been used as an example of oilseeds.

The term “oilseed” is different from “meal” of oilseed or “cake” of oilseed, which cannot longer be considered an oilseed. Oilseed cakes and meals are the residues remaining after removal of the greater part of the oil from oilseeds.

Thus, in an embodiment according to the invention oilseed refers to whole oilseeds which may be completely or partially dehulled.

### Step b)

The pH during step b) may vary. Thus, in an embodiment, milling step b) takes place at a pH in the range 5.5-6, preferably in the range 5.6-5.8, such as at pH 5.7. As outlined in Example 3 (Table 4) a pH around 5.7 provides not only a high yield but also the highest protein to oil ratio.

In an embodiment, in milling step b), the wet-milling includes water as the diluent.

In another embodiment in milling step b), wet-milling takes place a ratio of water to seed, by weight, in the range 5:1 to 1:5, such as 3:1 to 1:3, such as 2:1 to 1:2, preferably 2:1 to 1:0.7, more preferably 1.7:1 to 1:1.

In yet another embodiment, milling step b), takes place for 1-15 minutes, such as 1-10 minutes, such as 1-5 minutes. Milling conditions may be 2 minutes at 13500 rpm using an ultraturrax, but this may differ under large scale production or if using other equipment is used e.g. if a continues process is used.

In an embodiment, milling step b) is performed using shearmilling.

It is advantageous if alkaline solvents can be avoided or minimized in the process. Thus, in an embodiment, in milling step b), the wet-milling is free or substantially free from alkaline solvents, such as having a content of alkaline solvents below 1% by weight, such as below 0.1%, such as 0.01%, preferably being free of alkaline solvents, such as NaOH, KOH, phosphates, citrates and similar buffering salts.

In an embodiment, milling step b) takes place in an added aqueous solution having a content of added NaCl below 1% wt, such as below 0.5% wt, such as below 0.2% wt, such as being free or substantially free of added NaCl.

### Step c)

The process may further comprise a dilution step. Thus, in an embodiment, the process further comprises the dilution step c), wherein the product from step b) is diluted in water. In another embodiment, in dilution step c), the mixture is diluted to a water:seed ratio, by weight, of 20:1 to 5:1, preferably 15:1 to 5:1, more preferably 12:1 to 6:1, such as 10:1 to 8:1, or 9:1 by weight.

### Step d)

It may also be advantageous to include an enzymatic treatment step. Thus, in an embodiment, the process further comprises the enzyme treatment step d). In a related embodiment, enzyme treatment step d) includes pectinase treatment and/or cellulose treatment and/or protease treatment, preferably pectinase treatment. In example 4, a pectinase treatment step is included, which shows that the recovery of protein (%) is increased (Table 6).

Pectinases are a group of enzymes that breaks down pectin, a polysaccharide found in plant cell walls, through hydrolysis, transelimination and deesterification reactions. Commonly referred to as pectic enzymes, they include pectolyase, pectozyme, and polygalacturonase.

### Step e)

Mixing step e) may take place at different temperatures for different periods of time. Mixing may depend on the volumes and sizes of the batches used, and may include the use of various conditions for optimizing reactions such as enzymatic treatments or extractions. It may also depend on the size of buffering/mixing tanks present in the factory. In an embodiment, mixing step e) takes place at a temperature in the range 15-30° C., preferably in the range 20-25° C. In yet an embodiment, step e) takes place for a period of at least 2 hours, such as for a period of 2-10 hours, such as 2-8 hours, preferably 2-6 hours, such as 3-5 hours.

### Step f)

Filtering step f) may take step using different means. Thus, in an embodiment, filtering step f), takes place by screw-pressing, preferably using a twin-screw press, such as an Angle juicer twin screw press. In yet an embodiment, the twin screw press comprises a filter having a cut-off below 1000 μm, such as below 800 μm, such as in the range 300-800 μm, preferably in the range 400-600 μm, such as 500 μm. The screw dimensions may be around 220 mm.

### Step g)

In an embodiment, centrifugation is used in step g), such as with a centrifugation force (g) in the range 1500-5000 g, preferably in the range 3000-4000 g. As also outlined in the background section much higher centrifugation forces (g) have previously been used (see e.g. Romero-Guzmán et al. 2020) in addition to higher pHs.

In another embodiment, decanting is used in step g), such as with a centrifugation force in the range 1500-5000, preferably in the range 3000-4000 g.

In an embodiment, centrifugation step g) takes place for a period of 10-60 minutes, preferably such as 20-40 minutes, more preferably 25-35 minutes.

In an embodiment, step g) takes place at a temperature in the range 1-10° C. preferably 2-8° C., more preferably 2-6° C. Low temperatures may be used to ease separation of the protein and oil fractions.

In a part of the invention step g) results in the provision of the soluble protein concentrate fraction (II.). again, the skilled person is able to remove the oil phase and the precipitate using standard means known to the skilled person.

### Step h)

In step h) the soluble protein concentrate fraction (II.) is provided. Fraction II. can be isolated from fractions I. and III. by means known to the skilled person after a centrifugation step has been performed, such as by removing fraction I. and fraction III. Fraction I can e.g. be removed by sieving fraction I and II through a coarse sieve leaving fraction I in the sieve. Fraction III may remain as a solid precipitate in the bottom of the centrifugation tube. Thus, in an embodiment fraction II is isolated from fraction I using mechanical separation, such as sieving. In another embodiment, fraction II is separated from fraction III by removing fraction II after fraction III is precipitated after centrifugation. Again, the skilled person may used other means for isolating fraction II from fraction I and fraction III.

As also outlined in the example section, the provided soluble protein concentrate fraction (II.) has unique properties. Thus, in an embodiment, the provided isolated protein concentrate fraction of step h):
has a protein content in the range 25-50 wt %; and/or
has an oil content below 5 wt %; and/or
a pH in the range 5-6.5; and/or
has protein:fat ratio, by wt % dry matter, in the range 10:1 to 40:1
has a protein solubility above 30, such as above 40, such as in the range 30-65, such as in the range 40-60 in the pH range 5-7, preferably in the pH range 5.5-6.5.

In an embodiment, the provided isolated protein concentrate fraction of step h) has a protein content of at least 30% wt %, such as in the range 30-50% such as 40-50% wt %. Example 1 and Example 4 show isolated protein concentrates with such high concentrations.

In an embodiment, the provided isolated protein concentrate fraction of step h) has an oil concentration below 4%, preferably below 3% and more preferably below 2%. Example 1 and Example 4 show isolated protein concentrates with such high low oil concentrations.

In an embodiment, the provided isolated protein concentrate fraction of step h) has an protein:oil ratio (% wt) of at least 10, such as at least 15, preferably at least 20, such as in the range 10-50, such as 15-40, or such as 20-30. Example 1 and Example 4 show isolated protein concentrates with such high protein:oil ratios.

In a preferred embodiment the provided isolated protein concentrate fraction of step h)
has a protein content in the range 25-50 wt %; and
has an oil content below 5 wt %; and
has protein:fat ratio, by wt % dry matter, in the range 10:1 to 40:1.

In another preferred embodiment, the provided isolated protein concentrate fraction of step h)
has a protein solubility above 30, such as above 40, such as in the range 30-65, such as in the range 40-60 in the pH range 5-7, preferably in the pH range 5.5-6.5.

As shown in example 6, the provided isolated protein concentrate fraction of step h) has a unique solubility profile (as defined as the relative turbidity (500 nm) after pH adjustment and ultracentrifugation at 10,000 g for 20 min).

### Further Steps

The process according to the invention may comprise further steps. Thus, in an embodiment, the process further comprises the step of spray drying the isolated protein concentrate fraction, to provide a protein powder.

In another embodiment, the process further comprises the step of pasteurizing the isolated protein concentrate fraction, such as at a temperature of 72° C. for 15 seconds.

In a preferred embodiment, the process comprises
a) providing rapeseeds, preferably completely or partially dehulled;
b) wet-milling the rapeseeds from step a) at a pH in the range 5-6;
c) diluting/solubilising the wet-milled oilseed from step b) in water to a water:seed ratio of at least 5:1 (by weight), thereby providing an oilseed slurry;
d) optionally, enzyme treating the mixture of step b) and/or step c), such as pectinase enzyme treatment;
e) mixing the wet-milled oilseed from step c);
f) filtering the oilseed slurry from step d) to remove insoluble oilseed fragments, preferably using a twin-screw press, thereby providing an oilseed slurry filtrate;
g) centrifuging the oilseed slurry filtrate, preferably at a speed in the range 3000-4000 g at a temperature below 10° C., to provide an oilseed slurry filtrate comprising at least three phases:
   I. a lipid fraction;
   II. a soluble protein concentrate fraction; and
   III. a precipitate fraction comprising fibers;
h) providing the soluble protein concentrate fraction (II.).

### Product by Process

As also outlined above, the provided soluble protein concentrate fraction (II.) has unique properties. Thus, an aspect of the invention relates to a protein containing oilseed extract obtained/obtainable by a process according to the invention.

### Oilseed Extract Composition

Again, as also outlined above, the provided soluble protein concentrate fraction (II.) has unique properties. Thus, another aspect of the invention relates to an oilseed extract composition having
a protein content in the range 25-50 wt %; and/or
an oil content below 5 wt %; and/or
a pH in the range 5-6.5; and/or
a protein:fat ratio, by wt % dry matter, in the range 10:1 to 40:1
a protein solubility above 30, such as above 40, such as in the range 30-65, such as in the range 40-60 in the pH range 5-7, preferably in the pH range 5.5-6.5.

In an aspect, the invention relates to a soluble protein concentrate (II.) from whole (or dehulled whole) oilseeds having
a protein content in the range 25-50 wt %; and
an oil content below 5 wt %; and
a protein to fat ratio, by wt % dry matter, in the range 10:1 to 40:1.
   wherein the soluble protein concentrate (II.) has a pH in the range 5-6.

In a preferred embodiment the oilseed extract composition
has a protein content in the range 25-50 wt %; and
has an oil content below 5 wt %; and
has protein:fat ratio, by wt % dry matter, in the range 10:1 to 40:1.

In another preferred embodiment, the oilseed extract composition has a protein solubility above 30%, such as above 40%, such as in the range 30-65%, such as in the range 40-60% in the pH range 5-7, preferably in the pH range 5.5-6.5. Protein solubility (%) is defined as the colloidal stability, turbidity (500 nm) determined before and after centrifugation at 10,000 g. The solubility is the relative turbidity after centrifugation compared to before.

As shown in example 6, the provided isolated protein concentrate fraction of step h) has a unique solubility profile. This solubility profile can also be modified by further treatment with enzymes.

In an embodiment, the oilseed extract composition according to the invention has a content of NaCl below 1% wt, such as below 0.5% wt, such as below 0.2% wt.

### Uses

The protein containing oilseed extract obtained/obtainable by a process according to the invention and/or the oilseed extract according to the invention may be particularly relevant in the production of food/feed. Thus, an aspect of the invention relates to the use of a protein containing oilseed extract obtained/obtainable by a process according to the invention and/or the oilseed extract according to the invention, in the production of food/feed.

### Food/Feed Ingredients and Food/Feed Products

Yet an aspect relates to a food/feed ingredient comprising the protein containing oilseed extract obtained/obtainable by a process according to the invention and/or the oilseed extract according to the invention.

Yet a further aspect of the invention relates to a food/feed product comprising the food ingredient according to the invention. Thus, the protein slurry may be a used as a base for food products, by addition of other ingredients (as for example a drink, or fermented drink). Again, the protein suspension with the addition of flavors and stabilizers and other ingredients can be used as a food product.

### Gelling Agents, Foaming Agents and Emulsifiers

An additional aspect of the invention relates to the use of the protein containing oilseed extract obtained/obtainable by a process according to the invention and/or the oilseed extract according to the invention or the food ingredient according to the invention as a gelling agent, a foaming agent and/or as an emulsifier.

### Items of the Invention

1. A process for manufacturing protein concentrates from oilseed, such as rapeseed, the process comprising
a) providing oilseeds, preferably completely or partially dehulled;
b) wet-milling the oilseeds from step a) at a pH below 6.5, such as in the range 5-6;
c) optionally, diluting/solubilising the wet-milled oilseed from step b);
thereby providing an oilseed slurry;
d) optionally, enzyme treating the mixture of step b) and/or step c), such as pectinase enzyme treatment;
e) mixing the wet-milled oilseed from step b) or oilseed slurry from step c);
f) separating insoluble fragments, by separating the oilseed slurry from step e) preferably using a twin-screw press, thereby providing an oilseed slurry filtrate;
g) separating the fat from the aqueous slurry, by centrifuging or decanting the oilseed slurry filtrate, preferably at g values in the range 1500-5000 g, to provide an oilseed slurry filtrate comprising at least three fractions:
   I. a lipid fraction;
   II. a soluble protein concentrate fraction; and
   III. a precipitate fraction, comprising fibers;
h) providing the soluble protein concentrate fraction (II.).

2. The process according to item 1, further comprising providing the lipid fraction (I.), such as an oil fraction.

3. The process according to any of the preceding items, wherein the oilseed is rapeseed.

4. The process according to any of the preceding items, wherein milling step b) takes place at a pH in the range 5.5-6, preferably in the range 5.6-5.8, such as at pH 5.7.

5. The process according to any of the preceding items, further comprising the enzyme treatment step d), preferably wherein enzyme treatment step d) includes pectinase treatment and/or protease treatment, more preferably pectinase treatment.

6. The process according to any of the preceding items, wherein filtering step f), takes place by screw-pressing, preferably using a twin-screw press.

7. The process according to any of the preceding items, step g) takes place at a centrifugation force in the range of 3000-4000 g.

8. The process according to any of the preceding items, wherein step g) takes place at a temperature in the range 1-10° C. preferably 2-8° C., more preferably 2-6° C.

9. The process according to any of the preceding items, wherein the provided isolated protein concentrate fraction of step h):
has a protein content in the range 25-50 wt %; and
has an oil content below 5 wt %; and
has protein:fat ratio, by wt % dry matter, in the range 10:1 to 40:1.

10. The process according to any of the preceding items, further comprising the step of spray drying the isolated protein concentrate fraction, to provide a protein powder.

11. A protein containing oilseed extract obtained/obtainable by a process according to any of items 1-10.

12. An oilseed extract composition having
a protein content in the range 25-50 wt %; and
an oil content below 5 wt %; and
a protein to fat ratio, by wt % dry matter, in the range 10:1 to 40:1.

13. Use of a composition according to any of items 11-12, in the production of food/feed.

14. A food/feed ingredient comprising the composition according to any of items 11-12.

15. Use of a composition according to any of items 11-12 as a gelling agent, a foaming agent and/or as an emulsifier.

### REFERENCES

van der Goot, A. J., Pelgrom, P. J. M., Berghout, J. A. M., Geerts, M. E. J., Jankowiak, L., Hardt, N. A., Keijer, J., Schutyser, M. A. I., Nikiforidis, C. V., Boom, R. M., 2016. “Concepts for further sustainable production of foods.” Journal of Food Engineering 168 (July 2015).
Ntone, Eleni, Johannes H. Bitter, and Constantinos V. Nikiforidis. “Not Sequentially but Simultaneously: Facile Extraction of Proteins and Oleosomes from Oilseeds.” Food Hydrocolloids 102 (May 2020): 105598.
Ntone, Eleni, Qiyang Qu, Kindi Pyta Gani, Marcel B. J. Meinders, Leonard M. C. Sagis, Johannes H. Bitter, and Constantinos V. Nikiforidis. “Sinapic Acid Impacts the Emulsifying Properties of Rapeseed Proteins at Acidic PH.” Food Hydrocolloids 125 (April 2022): 107423.
Romero-Guzman, M. J., L. Jung, K. Kyriakopoulou, R. M. Boom, and C. V. Nikiforidis. “Efficient Single-Step Rapeseed Oleosome Extraction Using Twin-Screw Press.” Journal of Food Engineering 276 (July 2020): 109890.
Vidal, Natalia P., Roman, Laura, Swaraj, Shiva V. J., Ragavan, K. V., Simsek, Seney, Rahimi, Jamshid, Kroetsch, Benjamin, Martinez, Mario M. “Enhancing the nutritional value of cold-pressed oilseed cakes through extrusion cooking”. Innovative Food Science and Emerging Technologies 77 (May 2022): 102956.

It should be noted that embodiments and features described in the context of one of the aspects of the present invention also apply to the other aspects of the invention.

All patent and non-patent references cited in the present application, are hereby incorporated by reference in their entirety.

The invention will now be described in further details in the following non-limiting examples.

### EXAMPLES

### Example 1—Production of a Novel Defatted Rapeseed Protein Concentrate

### Aim of Study

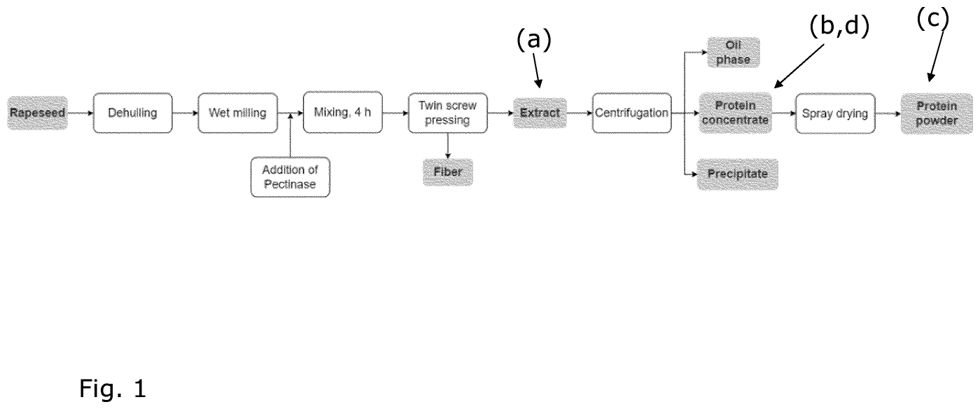

This example describes a procedure for production of a novel defatted rapeseed protein concentrate without the use of solvents. The process follows the schematic overview found in FIG. 1.

### Materials and Methods

Whole untreated rapeseeds grown in Denmark were used for protein extraction. The extraction process used in the example is summarized in FIG. 1. In brief, whole rapeseeds were partially dehulled using a Thermomix TM6 (Vorwerk, Wuppertal, Germany). The cracked rapeseeds were dispersed in water at a concentration of 40% rapeseed (w/w), and wet milled using an Ultra Turrax T-25 (IKA, Staufen, Germany) at 13500 rpm for two minutes. The suspension was then diluted to 10% (w/w), and milled for two additional minutes at 13500 rpm. The slurry was either kept at the original pH (5.7) and mixed for four hours on a magnetic stirrer at 600 rpm at room temperature (RCT basic, IKA, Staufen, Germany).

The extract, rich in oil, carbohydrates and protein, was obtained by pressing/filtering the slurry using a twin screw press (Angelia 7500, Angel, Juicer, Naarden, The Netherlands). The extract was then centrifuged at 3500 g for 30 minutes at 4° C. (SL 40R, ThermoFisher, Landsmeer, the Netherlands). After centrifugation the samples showed three separate phases: a lipid layer on top, a subnatant fraction (protein concentrate) and a precipitate at the bottom. The lipid layer is separated from the subnatant by pouring both phases through a sieve leaving the lipid phase in the sieve and the precipitate will remain in the centrifugation tube.

Additionally, an extra set of experiments applying lower centrifugation speed (2000 g) were also performed to investigate the effect of centrifugation speed on the separation of the olesomes from the protein rich fraction.

The composition of the protein extract (a) and soluble protein concentrate (b) was determined as follows:

The dry matter of the liquid protein concentrate was quantified using a Moisture Analyzer (HR73, Mettler Toledo, Columbus, USA) and expressed as g dry matter/100 g sample.

The concentration of protein was estimated using Nitrogen combustion method (Dumas, using a Dumatherm N Pro, Thermo Scientific, Waltham, Massachusetts, USA), with 5.7 as conversion factor. The concentration of oil was measured by carrying out a digestion (Hydrotherm, HT6, C. Gerhardt GmbH & Co. KG) using 4 M HCl followed by a Soxhlet extraction using petroleum ether as solvent. The protein and oil concentration is expressed as % of dry matter.

The presence of native protein is confirmed by the presence of an enthalpy transition peak by DSC analysis.

### Results

The composition of the protein extract (a), soluble protein concentrate (b) and spray dried protein powder (c), using rapeseed as an example, can be found in Table 1. Table 2 shows the composition of two soluble concentrates recovered after centrifugation speed 2000 g and 3500 g, respectively.

TABLE 1
Composition of the rapeseed protein extract (before centrifugation)
and the protein concentrate (after centrifugation)

| | Protein | Protein concentrate, |
|---|---|---|
| Product | extract (a) | liquid (b) |
| Dry matter (%) | 6.3 | 1.4 |
| Protein concentration | 18.5 | 43 |
| (% of dry matter) | | |
| Oil concentration | 64.8 | 1.7 |
| (% of dry matter) | | |
| Carbohydrate | 42 | 40 |
| concentration | | |
| (% of dry matter) | | |
| Polyphenol | 0.8 | 3.2 |
| concentration | | |
| (% of dry matter) | | |
| Protein:oil | 0.3 | 25 |

TABLE 2
Effect of centrifugation speed on defatting behaviour

| | Protein concentrate, | Protein concentrate, |
|---|---|---|
| Product | 2000 g | 3500 g |
| Dry matter (%) | 1.6 | 1.4 |
| Protein concentration | 37.3 | 43.0 |
| (% of dry matter) | | |
| Oil concentration | 11.2 | 1.7 |
| (% of dry matter) | | |
| Protein:oil | 3.3 | 25 |

### Conclusion

The process demonstrates how extraction and low speed (3500 g is still more efficient than 2000 g) centrifugation at acidic pH (pH 5.7) efficiently leads to separation of oil and protein resulting in a protein concentrate with high content of protein. The protein purity was remarkably higher than what is known from current processes. Furthermore, co-extraction of polyphenols was lower than what is known from current processes.

### Example 2—Spray Drying of the Protein Powder Achieved in Example 1

### Aim of Study

This example demonstrates that a white powder can be obtained using spray drying the novel defatted rapeseed protein concentrate produced in example 1.

### Materials and Methods

To achieve a product (c) with long shelf-life the protein concentrate (b) produced in example 1. was spray dried at low temperature conditions (inlet temperature 120° C. and outlet 57° C.) to maintain proteins in their native state.

The composition of the protein powder (c) was determined as described in example 1. The chemical composition of the powder is found in Table 3.

### Description of Powder:

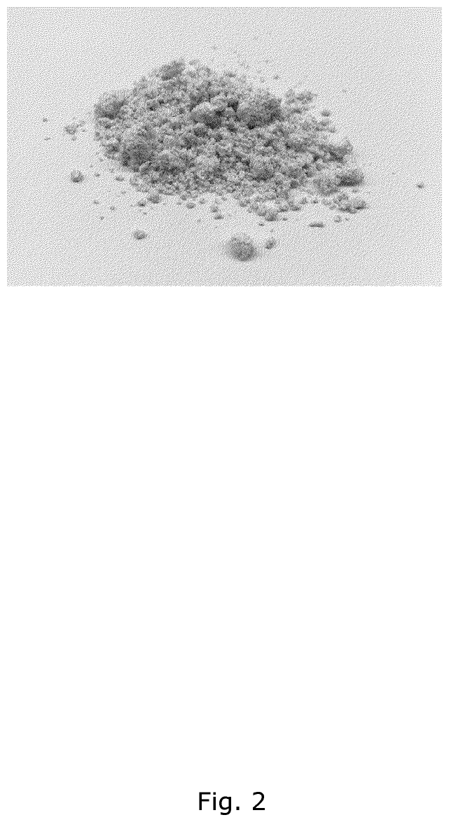

The spray dried powder had a light colour, as seen in FIG. 2, and a light and pleasant smell. The powder also maintained good dispersability, and was easily solubilized in water.

TABLE 3
Composition of spray dried rapeseed protein concentrate

| Product | Protein concentrate, powder (c) |
|---|---|
| Dry matter (%) | 94 |
| Protein concentration | 33 |
| (% of dry matter) | |
| Polyphenol concentration | 2.2 |
| (% of dry matter) | |

### Example 3—pH of Protein Extraction

### Aim of Study

To determine the concentration of protein and oil at various pH conditions in the interval from 4.5 to 9.0 for rapeseed.

### Materials and Methods

The extraction procedure is based on the process described in example 1. In this example, the pH of the rapeseed slurry was adjusted to 4.5, 5.7, 7.0, 8.5 or 9.0 by addition of 1.0 M HCl or 1.0 M NaOH prior to mixing. The pH was maintained throughout the 4 hours of mixing by adding a few drops of either 1.0 M HCl or 1.0 M NaOH. Further processing of the slurry into a protein concentrate follows the procedure described in example 1

The dry matter, protein and oil content of the extracts achieved at the various extractions conditions (pH 4.5-9.0) was quantified by the same methods as described in example 1. The recoveries of protein and oil were calculated as described below.

The recovery of protein in the liquid protein concentrates is based on the difference in the amount of protein in the whole seed and the amount of protein in the liquid protein concentrates.

Recovery of oil in the liquid protein concentrates is based on the difference in the amount of oil present in the whole seed and the amount of oil in the liquid protein concentrate.

### Results

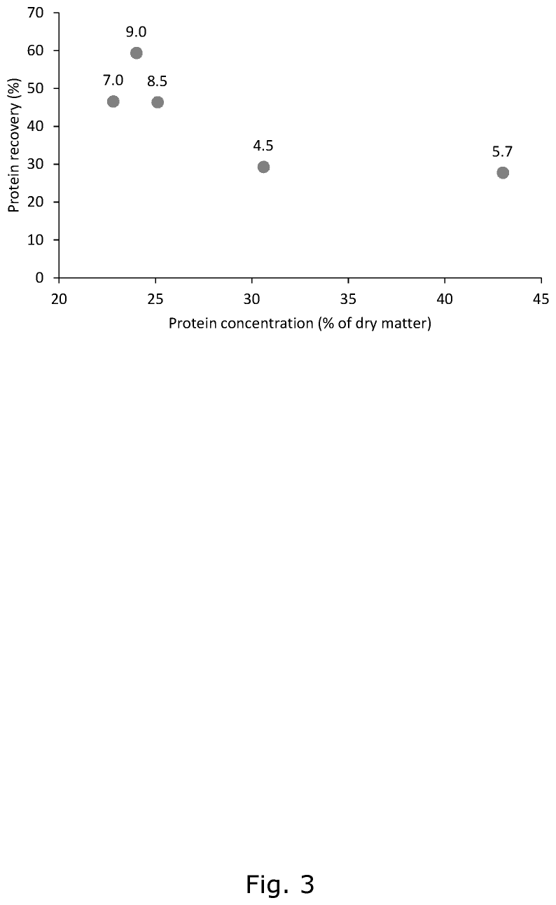

The chemical composition of the protein concentrates achieved at the various extraction conditions and the recoveries of protein and oil are found in Table 4 and 5 for rapeseed, FIG. 3 illustrates the relationship between rapeseed protein recovery and protein purity.

TABLE 4
The composition of the rapeseed protein concentrates
achieved at the various extraction conditions.

| Product | Protein concentrate, liquid (b) | | | | |
|---|---|---|---|---|---|
| Extraction pH | 4.5 | 5.7 | 7.0 | 8.5 | 9.0 |
| Dry matter (%) | 2.0 | 1.4 | 4.0 | 3.7 | 4.7 |
| Protein concentration | 31 | 43 | 23 | 25 | 24 |
| (% of dry matter) | | | | | |
| Oil concentration | 8 | 2 | 52 | 55 | 49 |
| (% of dry matter) | | | | | |
| Protein:oil | 3.9 | 21.5 | 0.4 | 0.5 | 0.5 |

TABLE 5
The recovery of rapeseed protein and oil
at the various extraction conditions.

| | |
|---|---|
| Product | Protein concentrate, liquid (b) |

| | | | | | |
|---|---|---|---|---|---|
| Extraction pH | 4.5 | 5.7 | 7.0 | 8.5 | 9.0 |
| Recovery of | 29 | 28 | 47 | 46 | 59 |
| protein (%) | | | | | |
| Recovery of | 2.5 | 0.4 | 35 | 34 | 39 |
| oil (%) | | | | | |

### Conclusion

Extraction at acidic pH results in protein concentrates rich in fiber and protein, with low residual lipid. Thus, resulting in a protein concentrate with higher protein purity than when produced at more alkaline conditions.

### Example 4—Enzyme Assisted Extraction

### Aim of Study

To evaluate protein recoveries after enzyme assisted extractions.

### Materials and Methods

The extraction procedure is based on the process described in example 1.

Commercial pectinase, Pectinex Ultra SP-L (3300 units/g) from Novozymes A/S (Bagsvaerd, Denmark) was added at a ratio of 100 mg/g rapeseed prior to the mixing step as seen in FIG. 1 resulting in a protein concentrate (d).

The recovery of protein in the liquid protein concentrates (d) is based on the difference in the amount of protein in the whole seed and the amount of protein in the liquid protein concentrates. The protein content was quantified by the same method as described in example 1.

The dry matter, protein and oil content of the pectinase assisted protein concentrate (d) was quantified by the same methods as described in example 1, and compared to the protein concentrate (b) produced in example 1. Recoveries of protein and oil were calculated as described in example 4.

### Results

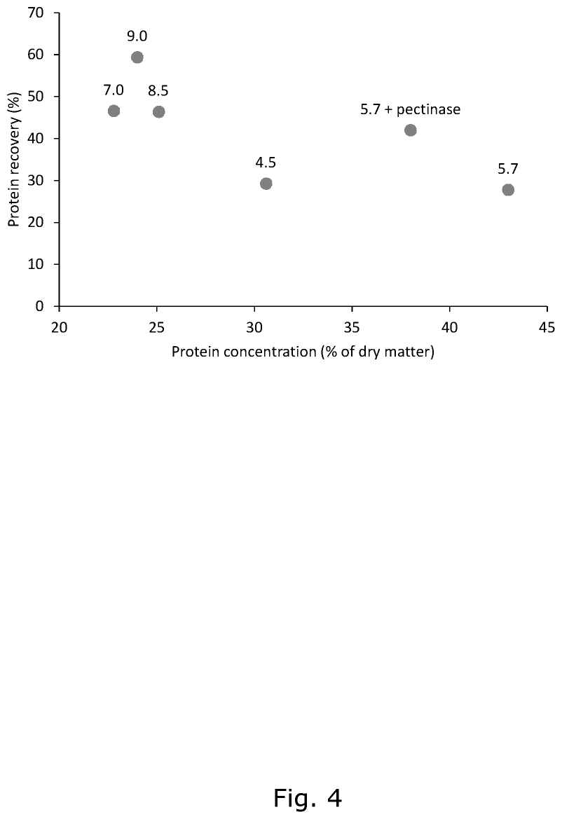

The chemical composition of the protein concentrates achieved without (b) and by pectinase assisted extraction (d) is shown in Table 6, and the recoveries of protein and oil are found in Table 7. FIG. 4 illustrates the relationship between protein recovery and protein purity.

TABLE 6
Composition of liquid slurry after extraction
with and without pectinase addition.

| | Protein concentrate, | Protein concentrate, |
|---|---|---|
| | liquid (b) | liquid (d) |
| Product | Without pectinase | With pectinase |
| Dry matter (%) | 1.4 | 2.0 |
| Protein concentration | 43 | 38 |
| (% of dry matter) | | |
| Oil concentration | 2 | 3 |
| (% of dry matter) | | |
| Protein:oil | 22 | 13 |

TABLE 7
Recovery of protein and oil.

| | Protein concentrate, | Protein concentrate, |
|---|---|---|
| | as is (b) | as is (d) |
| Product | Without pectinase | With pectinase |
| Recovery of | 28 | 42 |
| protein (%) | | |
| Recovery of | 0.4 | 1.2 |
| oil (%) | | |

### Conclusion

Extraction using pectinase increases the protein extraction recovery from the seed. These recovered levels are comparable to those reported for the alkaline extractions (see Table 5), while also providing a high protein:oil ratio at lower pH (5.7) compared to pH 9.0 (see Table 4).

### Example 5—Ultrafiltration

### Aim of Study

This example describes how the protein concentrate achieved in example 1 and 4 can be further treated using membrane filtration, and specifically in this example, by ultrafiltration to remove soluble polyphenols, low molecular weight components, such as oligo, di and monosaccharides, which may be present in the original slurry or produced during enzymatic treatments.

### Materials and Methods

An ultrafiltration step was performed after extraction to further increase the protein purity in the protein concentrate obtained after enzyme assisted filtration as described in example 4.

In this example, a polyethersulfone ultrafiltration membrane with a molecular weight cut off at 10 kDa was coupled to a cross flow filtration unit. The filtration was ran for 2 hours and permeate was collected at different timepoints (10, 20, 30, 50, 70, 90 and 120 min). The protein concentrate was kept cold during filtration (T<10° C.). A similar experiment was performed on the protein concentrate achieved in example 1, where the polyphenol content was quantified in the feed, retentate and permeate.

The nitrogen content of the permeate was quantified by nitrogen combustion as described in example 1.

SDS-PAGE under non-reducing conditions was used to determine the protein profile of the (rapeseed) protein concentrate and the permeate. Non-reducing conditions were chosen to better highlight the presence of cruciferin, napin and oleosomes. The protein concentrate were diluted in buffer (NuPAGE® LDS, ThermoFisher, Landsmeer, the Netherlands) to a final protein concentration of 1.0 mg/ml. The permeates were mixed with the buffer in a ratio 4:1. The gel (NuPAGE® Novex® 4-12% Bis-Tris Gel, ThermoFisher, Landsmeer, the Netherlands) was loaded with 5 μl protein marker (PageRuler™ Prestained Protein Ladder, 10-180 kDa, ThermoFisher, Landsmeer, the Netherlands) and 10 μl protein solution, and the chamber was filled with MES running buffer (NuPAGE® MES SDS Running Buffer, ThermoFisher, Landsmeer, the Netherlands) and ran for 35 minutes at 200 kV. The gels were washed and stained (Coomassie Brilliant Blue R-250 Staining Solution, Bio-Rad Laboratories B.V., Lunteren, the Netherlands) overnight. Bands were analyzed using the software Image Lab 6.1. (Bio-Rad Laboratories, Inc., USA).

Total polyphenol content was determined using the Folin-Ciocalteu assay. In brief polyphenols were extracted by mixing methanol and sample in a ratio 4:1, shake it for 1 hour minutes and centrifuging at 10.000 g for 10 min at 20° C. The supernatant was collected and diluted with water, pipetted into a microplate and Folin-Ciocalteu reagent and 0.5 M Na₂CO₃ was added. The microplate was incubated at room temperature for 2 hours and the absorbance was read at 765 nm. Gallic acid (Sigma Aldrich, St Louis, MO, USA) was used as standard.

### Results

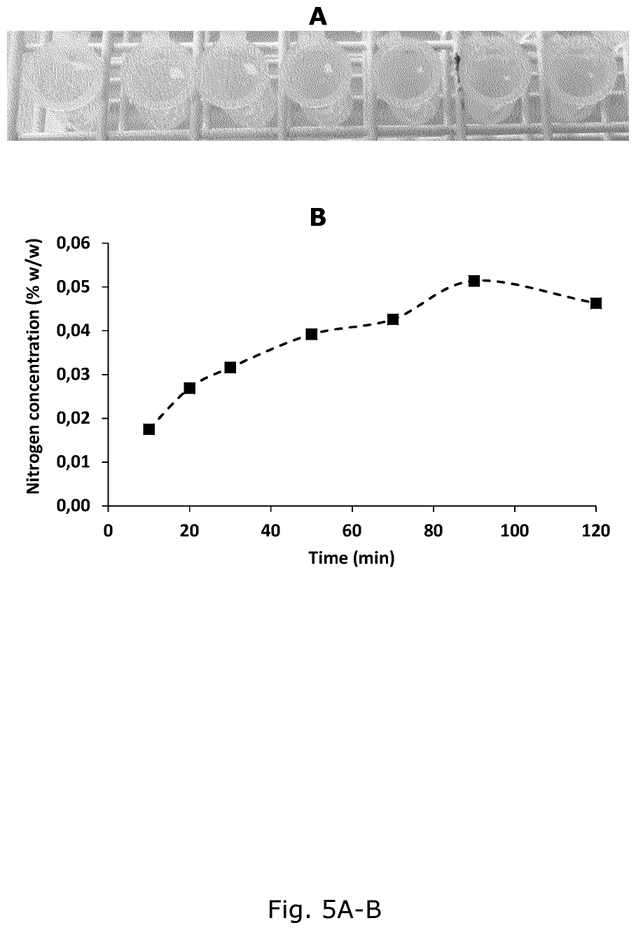

FIG. 5A shows permeate collected during ultrafiltration (10 kDa) of the protein concentrate (d) for 2 h. A clear yellow permeate is obtained. FIG. 5B shows nitrogen concentration (% w/w) in the permeate (the fraction transmitted through the membrane) during ultrafiltration (10 kDa) of the protein concentrate (d) for a time period of 2 hours.

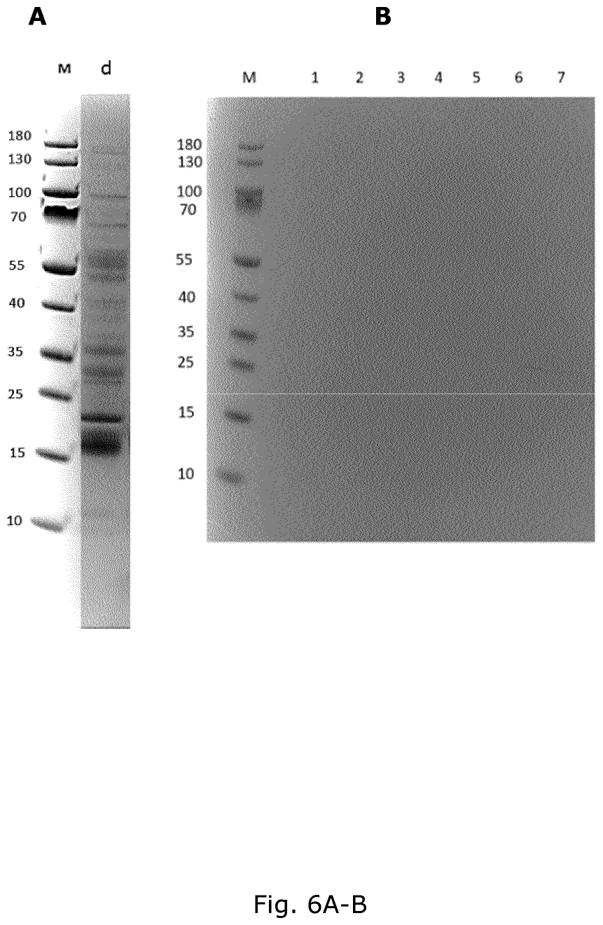

FIG. 6A shows the electrophoretic pattern measured by SDS-PAGE of the protein concentrate (the retentate fraction) achieved after enzyme assisted extraction (d). The analysis was performed under non-reducing conditions. FIG. 6B shows the electrophoretic pattern measured by SDS-PAGE of the permeate (the fraction transmitted through the filter) achieved from ultrafiltrating (10 kDa) the protein concentrate (d) for different time points for a 2 h duration (1-7). The analysis was conducted under non-reducing conditions.

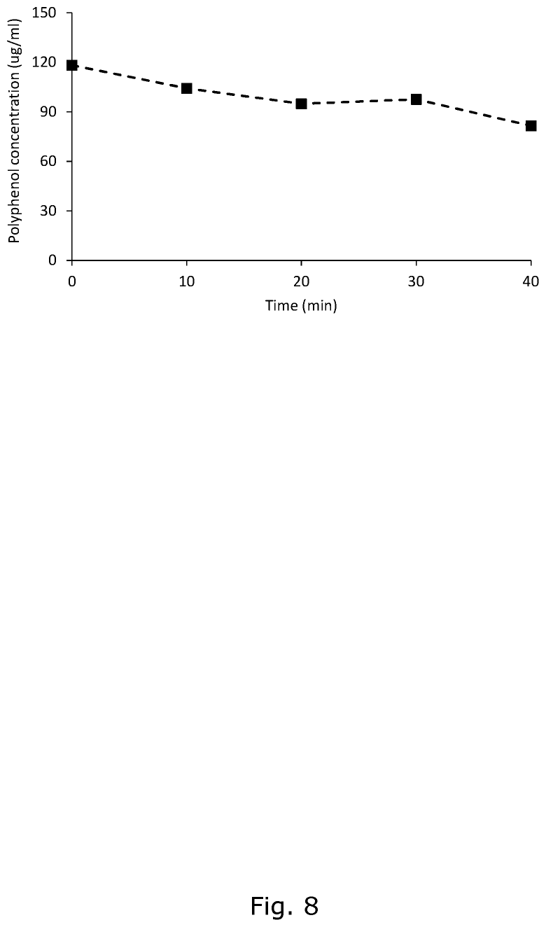

FIG. 8 shows the polyphenol concentration in the permeate at different timepoints during ultrafiltration (10 kDa) of the protein concentrate (b).

The polyphenol concentration of the protein concentrate before and after filtration is stated in Table 8.

TABLE 8
Polyphenol content before and after ultrafiltration (10 kDa)

| | Protein concentrate | Protein concentrate |
|---|---|---|
| Product | (b) | after filtration |
| Polyphenol content | 2.60 | 2.49 |
| (% of dm) | | |

### Conclusion

Non-protein nitrogen, such as glucosinolates, and pigments, such as polyphenols, can be removed from the protein concentrate by ultrafiltration (10 kDa), while concentrating the protein fraction in the retentate.

### Example 6—Foaming Properties

### Aim of Study

To compare the foaming properties of rapeseed protein concentrates extracted at acidic (5.7) and alkaline (8.5) conditions as described in example 3.

### Materials and Methods

The foaming properties of the concentrates were quantified by foam scan (Teclis Scientific, Civrieux-d'Azergues, France) using 250 ml/min in air flow for 100 s. The foaming capacity is defined as the amount (mL) of foam created after 100 s air flow. To compare the two extracts, the capacity were standardized to similar protein content, and the results are given as ml foam/g protein. The foam stability is defined as the time(s) for the foam to collapse to half the volume. The foaming properties were measured on the protein concentrates as is without any pH adjustment.

### Results

The foaming capacity and stability of the two protein concentrates extracted at pH 5.7 and 8.5 is shown in Table 13.

TABLE 13
Foaming properties of protein concentrates

| | Protein concentrate, | Protein concentrate, |
|---|---|---|
| | liquid (b) extracted | liquid extracted |
| Product | at pH 5.7 | at pH 8.5 |
| Foam capacity | 418 | 166 |
| (mL foam/g protein) | | |
| Foam stability (s) | 16 | 10 |

### Conclusion

The foaming properties of the defatted protein concentrate extracted at pH 5.7 is considerably better than for that extracted at pH 8.5 containing high amount of lipids.

### Example 7—Solubility

### Aim of Study

To describe the colloidal stability of the protein fraction as a function of pH of the oilseed protein concentrate achieved in example 1, 2 (powder) and 3 (pH 9).

### Materials and Methods

### pH Stability

The solubility of the protein fraction as a function of pH was measured as turbidity at 500 nm. The turbidity was measured at various pH values in the range between 3.0 to 10.0. The colloidal stability of two rapeseed extracts are compared, that extracted at pH 5.7 and 9.0. In addition, the solubility of the powder (2) was evaluated after being reconstructed in water and then pH adjusted to the various pH conditions (pH 3-10).

Protein concentrates extracted at either pH 5.7 or at pH 9.0 were pH adjusted in the pH interval 3.0 to 10.0 by using 1.0 M HCl and 1.0 M NaOH. After pH adjustments a part of the sample were ultracentrifuged (i.e. 10,000 g, t=30 min and T=20° C.) (5417R microcentrifuge, Eppendorf AG, Hamburg, Germany).

The turbidity of the supernatants were measured at wavelength 500 nm by a microplate spectrophotometer (Synergy 2 microplate reader, Agilent Technologies, CA, United states), and data is reported as percentage turbidity relative to the original extract.

### Results

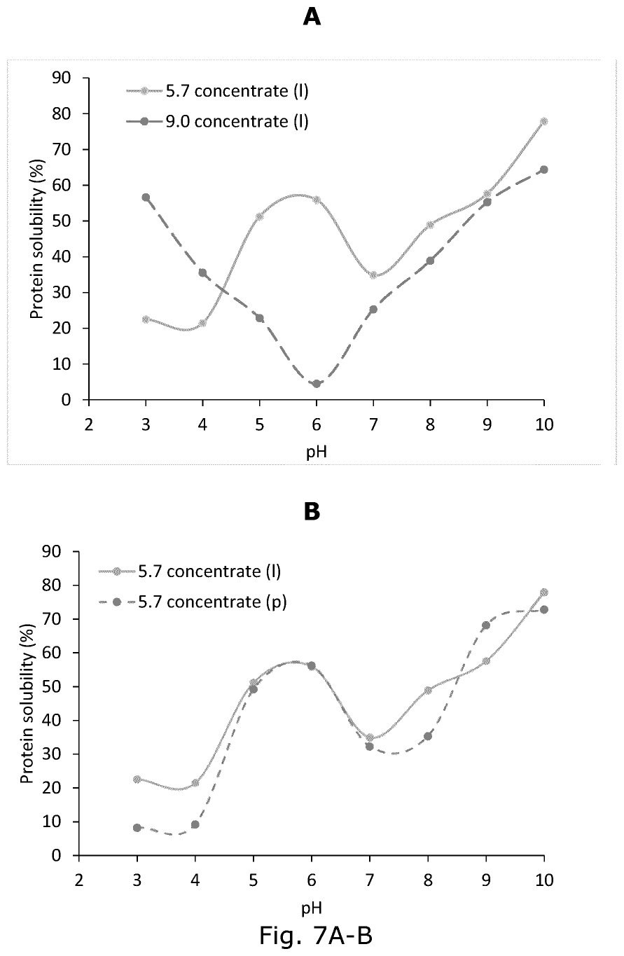

FIG. 7A shows the turbidity of protein concentrates extracted at pH 5.7 and 9.0 in the pH interval 3.0-10.0. FIG. 7B shows the turbidity of the protein concentrates extracted at pH 5.7 as a liquid concentrate (b) and as a spray dried powder (c) in the pH interval 3.0-10.0.

### Conclusion

Protein solubility is quite different for extracts at acidic or alkaline pH. Rapeseed protein concentrate achieved at acidic pH (i.e. 5.7) has two pH ranges of maximum solubility, and a opposite “u” type behaviour compared to conventional plant based isolates. The protein concentrate extracted at pH 9 shows the conventional “u” type behaviour. It is possible to fine tune this behaviour with targeted enzymatic modifications.

It is considered that this behaviour will also influence gelling properties, emulsification properties and foaming properties.

### Example 8—Protein Modifications

### Aim of Study

To demonstrate how protein hydrolysis using commercial endo-proteases can be used to modify the protein solubility of the protein concentrate created in example 1.

### Materials and Methods

Protein hydrolysis were performed by adding 2 ml of commercial enzyme (alcalase or neutrase) to 150 ml protein concentrate (b). Protamex was used as dry powder and 1 g was added to 150 ml. The hydrolysis were performed at T=55° C. for 4 hours at the natural pH of the concentrate. The hydrolysis were followed by enzyme inactivation at 90° C. for 5 min. The control sample without addition of enzyme were also heat treated at 90° C. for 5 minutes.

The protein solubility were defined as the turbidity (500 nm) and analyzed as in example 6. However, no pH adjustments were performed on the samples prior to centrifugation.

### Results

The protein solubility, which is defined as the turbidity, for the protein concentrates modified by different proteases is stated in Table 14.

TABLE 14
Protein solubility of modified protein concentrates.

| | Protein concentrate, | | | |
|---|---|---|---|---|
| Product | liquid (b) | +alcalase | +neutrase | +protamex |
| Protein | 10 | 34 | 26 | 41 |
| solubility | | | | |
| (%) | | | | |

### Conclusion

Hydrolysis of the rapeseed proteins improve the protein solubility, hence can be used to improve the functional and nutritional properties of the product.

1. A process for manufacturing protein concentrates from whole oilseed, the process comprising
a) providing whole oilseeds;
b) wet-milling the whole oilseeds from step a) at a pH in the range 5-6;
c) mixing the wet-milled oilseed from step b);
d) separating insoluble fragments, by separating the oilseed slurry from step c) by screw-pressing, thereby providing an oilseed slurry extract;
e) centrifuging the oilseed slurry extract from step d), to provide at least three fractions:
I. a lipid fraction;
II. a soluble protein concentrate fraction; and
III. a precipitate fraction, comprising fibers;
f) isolating the soluble protein concentrate fraction (II.).

2. The process according to claim 1, further comprising providing the lipid fraction (I.).

3. The process according to claim 1, wherein the oilseed is selected from the group consisting of rapeseed, sunflower, hemp, almonds and peanuts.

4. The process according to claim 1, wherein the oilseed is completely or partially dehulled whole rapeseed.

5. The process according to claim 1, wherein milling step b) takes place at a pH in the range 5.5-6.

6. The process according to claim 1, wherein milling step b) takes place in an added aqueous solution, preferably water.

7. The process according to claim 1, wherein milling step b) takes place in an added aqueous solution having a content of NaCl below 1% wt.

8. The process according to claim 1, wherein in milling step b), the wet-milling is free or substantially free from alkaline solvents.

9. The process according to further comprising an enzyme treatment step after step b).

10. (canceled)

11. (canceled)

12. (canceled)

13. The process according to claim 1, further comprising an enzyme treatment step after step b), wherein the enzyme treatment step is pectinase treatment.

14. The process according to claim 1, wherein filtering step f), takes place by using a twin-screw press.

15. The process according to claim 1, wherein step e) takes place at a centrifugation force in the range of 1500-500 g.

16. The process according to claim 1, wherein step e) takes place at a temperature in the range 1-10° C.

17. The process according to claim 1, wherein the provided isolated protein concentrate fraction of step f):
has a protein content in the range 25-50 wt %; and
has an oil content below 5 wt %; and
has protein:fat ratio, by wt % dry matter, in the range 10:1 to 40:1.

18. The process according to claim 1, wherein the provided isolated protein concentrate fraction of step hf) has a protein solubility above 30%.

19. The process according to claim 1, further comprising the step of spray drying the isolated protein concentrate fraction, to provide a protein powder.

20. (canceled)

21. A soluble protein concentrate from whole oilseed having
a protein content in the range 25-50 wt %; and
an oil content below 5 wt %; and
a protein to fat ratio, by wt % dry matter, in the range 10:1 to 40:1,
wherein the soluble protein concentrate has a pH in the range 5-6.

22. The soluble protein concentrate according to claim 21, having a protein solubility above 30%.

23. The soluble protein concentrate according to claim 21, having a content of NaCl below 1% wt.

24. (canceled)

25. (canceled)

26. Use of an oilseed extract composition according to claim 21 as a gelling agent, a foaming agent and/or as an emulsifier.
